(19) United States
(12) Patent Application Publication
(10) Pub. No.: US 2013/0148751 A1
(43) Pub. Date: Jun. 13, 2013

(54) MANAGING DIGITAL RADIO COMMUNICATIONS

(71) Applicant: David B. Kumhyr, Austin, TX (US)

(72) Inventor: David B. Kumhyr, Austin, TX (US)

(73) Assignee: INTERNATIONAL BUSINESS MACHINES CORPORATION, Armonk, NY (US)

(21) Appl. No.: 13/461,759

(22) Filed: May 1, 2012

Related U.S. Application Data
(63) Continuation of application No. 13/324,033, filed on Dec. 13, 2011.

(51) Int. Cl. H04W 4/08

(52) U.S. Cl. 375/259

(57) ABSTRACT

A method for managing digital radio transmissions including determining a group of selected radio receiving units for a set of digital radio transmissions according to a policy, and transmitting the set of digital radio transmissions by a radio transmitting unit only to the group of selected radio receiving units.

This application is a continuation of application Ser. No. 13/324,033 filed Dec. 13, 2011 entitled “MANAGING DIGITAL RADIO COMMUNICATIONS”, the disclosure of which is incorporated in its entirety herein by reference.

### BACKGROUND

1. Technical Field

The present invention relates generally to managing digital radio communications, and in particular, to a computer implemented method for managing the distribution of digital radio transmissions.

2. Description of Related Art

Communications distribution between dispatchers and emergency personnel and among emergency personnel has traditionally been frequency based. Police may use one set of frequencies, firemen another set of frequencies, and other types of emergency personnel may use additional frequencies. Even within an agency such as police, different groups within a geographic region may distribute communications by frequency. This approach has led to a shortage of frequency spectrum in crowded areas. In addition, often emergency personnel may listen to large amounts of radio traffic not related to their activities.

The advent of non-voice computer communications between dispatchers and emergency personnel has helped alleviate this issue to an extent. That is, a dispatcher may communicate with a police officer about a minor reported incident solely by sending information to that officer's computer terminal. However, it may be difficult for an officer to read such information while driving a vehicle.

### SUMMARY

The illustrative embodiments provide a method for managing digital radio transmissions including determining a group of selected radio receiving units for a set of digital radio transmissions according to a policy, and transmitting the set of digital radio transmissions by a radio transmitting unit only to the group of selected radio receiving units.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of a network of data processing systems in which various embodiments may be implemented;

FIG. 2 is a block diagram of a data processing system in which various embodiments may be implemented;

FIG. 3 is a diagram of the workstation communication equipment of a dispatcher and the vehicle communication equipment of a police officer in which various embodiments may be implemented;

FIGS. 4A through 4E illustrate various data structures which may be used in accordance with a first embodiment;

FIGS. 5A and 5B are flowcharts of the application of a policy to an incident in which various embodiments may be implemented;

FIGS. 6A and 6B are pictorial representations of a display which may be viewed by a dispatcher or a police officer or other emergency personnel in which various embodiments may be implemented;

FIGS. 7A through 7E illustrate various data structures which may be used in accordance with a second embodiment; and

FIG. 8 is a flowchart of a user modifying a policy allocation in which various embodiments may be implemented.

### DETAILED DESCRIPTION

Steps may be taken to manage the distribution of digital communications. These steps may be taken as will be explained with reference to the various embodiments below.

FIG. 1 is a block diagram of a network of data processing systems in which various embodiments may be implemented. Data processing environment 100 is a network of data processing systems also known as computers or computer devices in which the embodiments may be implemented. Software applications may execute on any computer or other type of data processing system in data processing environment 100. Data processing environment 100 includes network 110. Network 110 is the medium used to provide communications links between various devices and computers connected together within data processing environment 100. Network 110 may include connections such as wire, wireless communication links, or fiber optic cables.

Servers 120 and 122 and client 140 are coupled to network 110 along with storage unit 130. In addition, laptop 150 and facility 180 (such as a home or business) are coupled to network 110 including wirelessly such as through a network router 153. A mobile radio 160 (such as a mobile phone), vehicle 170, and dispatcher 190 are also coupled to network 110 through a mobile radio tower 162 (such as a police radio tower or a cellular tower). Data processing systems, such as server 120 and 122, client 140, laptop 150, mobile radio 160, vehicle 170, facility 180 and dispatcher 190 contain data and have software applications including software tools executing thereon. Other types of data processing systems such as personal digital assistants (PDAs), smartphones, tablets and netbooks may be coupled to network 110.

Server 120 may include software application 124 such as for managing the distribution of digital communications or other software applications in accordance with embodiments described herein. Storage 130 may contain a content such policy data 136 for managing the distribution of digital communications or other content for sharing among various computer or other data processing devices. Client 140 may include software application 144. Laptop 150 and mobile radio 160 may also include software applications 154 and 164. Vehicle 170, facility 180 and dispatcher 190 may include software applications 174, 184 and 194. Other types of data processing systems coupled to network 110 may also include software applications. Software applications could include a web browser, email, or other software application that can manage the distribution of digital communications or other type of information to be processed.

Servers 120 and 122, storage unit 130, client 140, laptop 150, mobile radio 160, vehicle 170, facility 180, and dispatcher 190 and other data processing devices may couple to network 102 using wired connections, wireless communication protocols, or other suitable data connectivity. Clients 140 may be, for example, personal computers or network computers.

In the depicted example, server 120 may provide data, such as boot files, operating system images, and applications to client 140 and laptop 150. Client 140 and laptop 150 may be clients to server 120 in this example. Client 140, laptop 150, mobile radio 160, vehicle 170, facility 180, and dispatcher 190 or some combination thereof, may include their own data, boot files, operating system images, and applications. Data processing environment 100 may include additional servers, clients, and other devices that are not shown.

In the depicted example, data processing environment 100 may be the Internet. Network 110 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

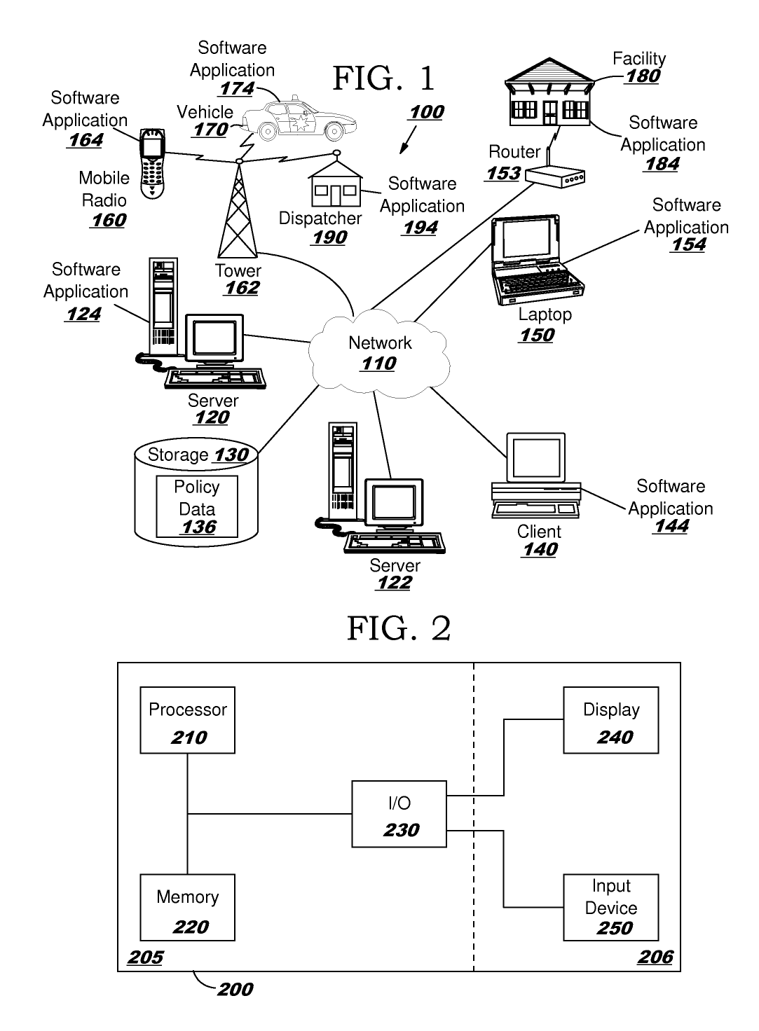

FIG. 2 is a block diagram of a data processing system in which various embodiments may be implemented. Data processing system 200 is an example of a computer device, such as server 120, client 140, laptop 150, mobile radio 160, vehicle 170, facility 180 or dispatcher 190 in FIG. 1, in which computer usable program code or instructions implementing the processes may be located for the illustrative embodiments.

In the depicted example, data processing system 200 includes a CPU or central processing unit 210 which may contain one or more processors and may be implemented using one or more heterogeneous processor systems including a graphics processor. The depicted example also includes a memory 220 which may be used for storing instructions and data to be processed by CPU 210. Memory 220 may include a main memory composed of random access memory (RAM), read only memory (ROM), or other types of storage devices. Memory 210 could also include secondary storage devices such as a hard disk drive, DVD drive or other devices which may be internal or external to data processing system 200. An input output device (I/O) 230 is also shown in the depicted example for managing communications with various input devices and output devices. However, other examples could use the CPU to communicate directly with various input or output devices or use separate input and output controllers.

In the depicted example, a computer display 240 is shown for the data processing system to communicate with a user or another data processing system. Other types of output devices may be used such as an audio device. An input device 250 is also shown which may be a keyboard, mouse, a touch sensitive display, or other types of input devices.

Data processing system 200 is shown with an internal section 205 and an external section 206. Often input and output devices may be physically separate from but connected to the CPU and memory. However, that is often not the case with portable devices such as mobile phones.

An operating system may run on processor 210. The operating system coordinates and provides control of various components within data processing system 200 in FIG. 2. The operating system may be a commercially available operating system. An object oriented programming system may run in conjunction with the operating system and provides calls to the operating system from programs or applications executing on data processing system 200. Instructions for the operating system, the object-oriented programming system, and applications or programs may be located on secondary storage devices such a hard drive, and may be loaded into RAM for execution by processing unit 210.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1 and 2. In addition, the processes of the embodiments may be applied to a multiprocessor data processing system.

The depicted examples in FIGS. 1-2 and above-described examples are not meant to imply architectural limitations. For example, data processing system 200 may also be a mobile radio 160, tablet computer, laptop computer, or telephone device.

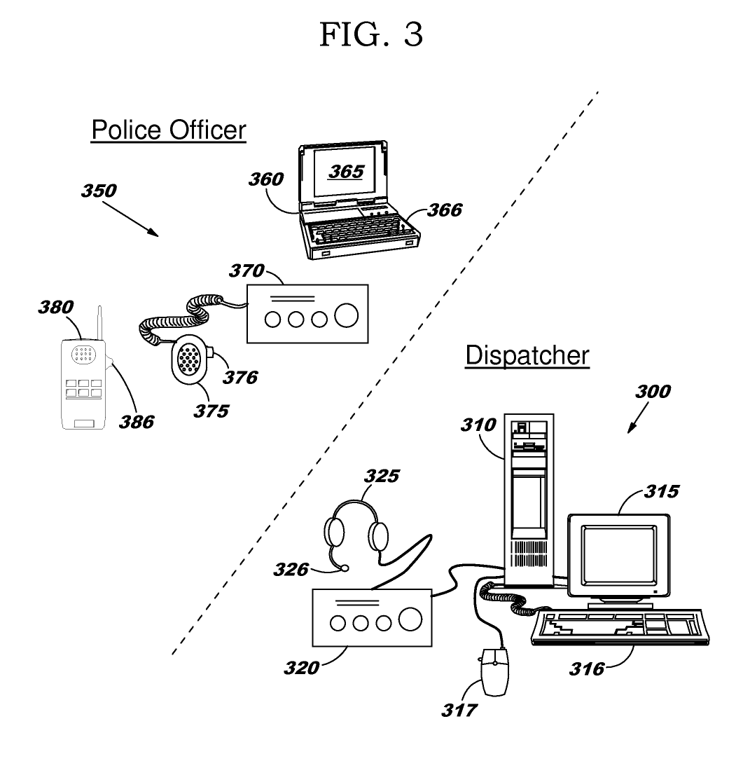

FIG. 3 is a diagram of the workstation communication equipment of a dispatcher and the vehicle communication equipment of a police officer in which various embodiments may be implemented. Although the equipment of a single dispatcher workstation and a single police officer vehicle are shown, the communication equipment of workstations and vehicles of multiple dispatchers and multiple police officers and/or other emergency personnel may be in direct communication with each other using similar equipment. These communications may be managed in accordance with the embodiments described below.

Dispatcher workstation 300 has a computer system 310 with a display 315, keyboard 316 and mouse 317. The computer system may be a laptop or tablet and may include touch sensitive screens to supplement or replace the keyboard. Multiple displays and computer systems may be used by the dispatcher. The dispatcher also has a digital radio 320 with headphones 325 including a microphone 326. The headset and microphone may be connected directly with the computer system. The dispatcher's radio is able to communicate on multiple bands (e.g. VHF, UHF) and frequencies with a variety of emergency personnel within a geographic region. Multiple digital radios may be used by the dispatcher. The dispatcher's computer system is coupled to the dispatcher's radio for managing radio communications. That is, each digital radio message may include a header which includes information about who is sending the message, who is receiving the message, and the subject of the message (e.g. an incident).

Police office workstation 350 is typically located in a police vehicle and includes a computer system 360 with a display 365 and keyboard 366. The computer system may be a laptop or tablet and may include touch sensitive screens to supplement or replace the keyboard. A mouse pad or other input device for moving a cursor may be built into the keyboard. Multiple displays and computer systems may be used by the dispatcher. Computer system 360 may be on an arm assembly so the police officer to swing the computer system out of the way when driving the vehicle. The police officer also has a digital radio 370 including a handset 375 with a key button 376 which the officer presses to initiate a conversation with the dispatcher or other emergency personnel such as a police officer. Another mobile digital radio 380 with a key button 386 is standard issue for a police officer. This allows the officer to maintain communications when the officer leaves the vehicle. Mobile digital radio 380 may be a handheld unit similar to a cell phone in appearance or it may be a unit located on the officer's belt coupled to a handset located on the officer's shoulder for easy access. The vehicle digital radio may acts as a repeater for a mobile digital radio. Each digital radio may be wirelessly coupled to computer system 360 wirelessly such as by Bluetooth. The vehicle digital radio may be coupled to computer system 360 by wire.

Dispatcher computer system 310 communicates with police officer computer system 360 typically through a cellular or other mobile phone type connection. Dispatcher radio 320 may communicate directly with vehicle radio 370 and mobile radio 380 on multiple bands and frequencies. Other police officers, dispatchers, emergency personnel, etc. may listen to or join in these communications depending on the policies as will be described below.

Dispatcher computer system 310 is coupled to the dispatcher radio 320 for managing radio communications with police officer radios 370 and 380. Each radio uses digital communications and use an identifying token or other identifying signal as a header for any radio traffic. That is, when an officer keys his mike (presses his radio key button) to initiate a communication, the radio will send the radio identifier in a small header packet so that other radios listening to that frequency will know which radio is initiating the communication. As will be explained below, that identifier and other information is used to manage which other radios or other communications devices will listen to the upcoming communication. The distribution of radio communications can be managed using policies and information stored in the server database and implemented using the software stored on each communication device.

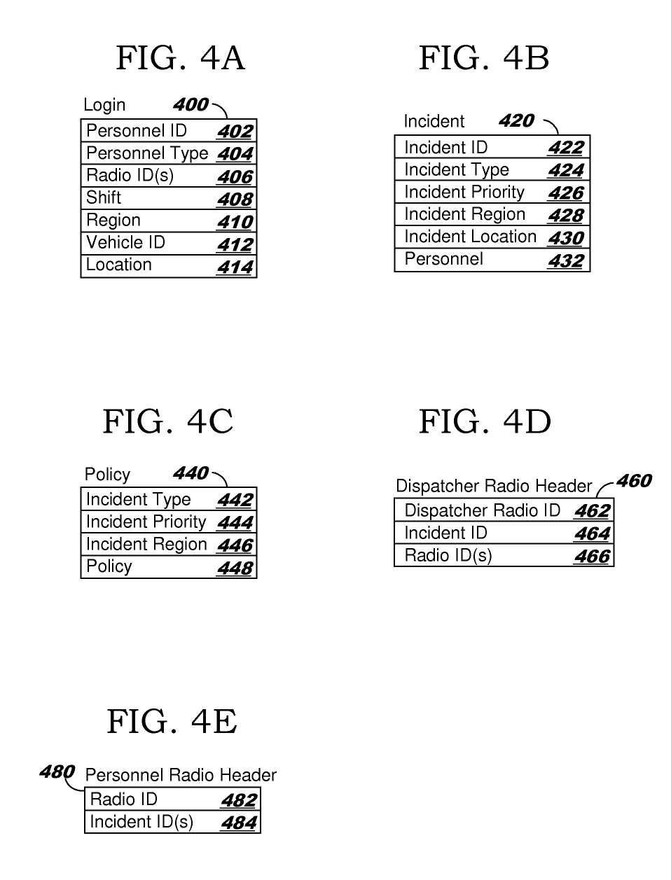

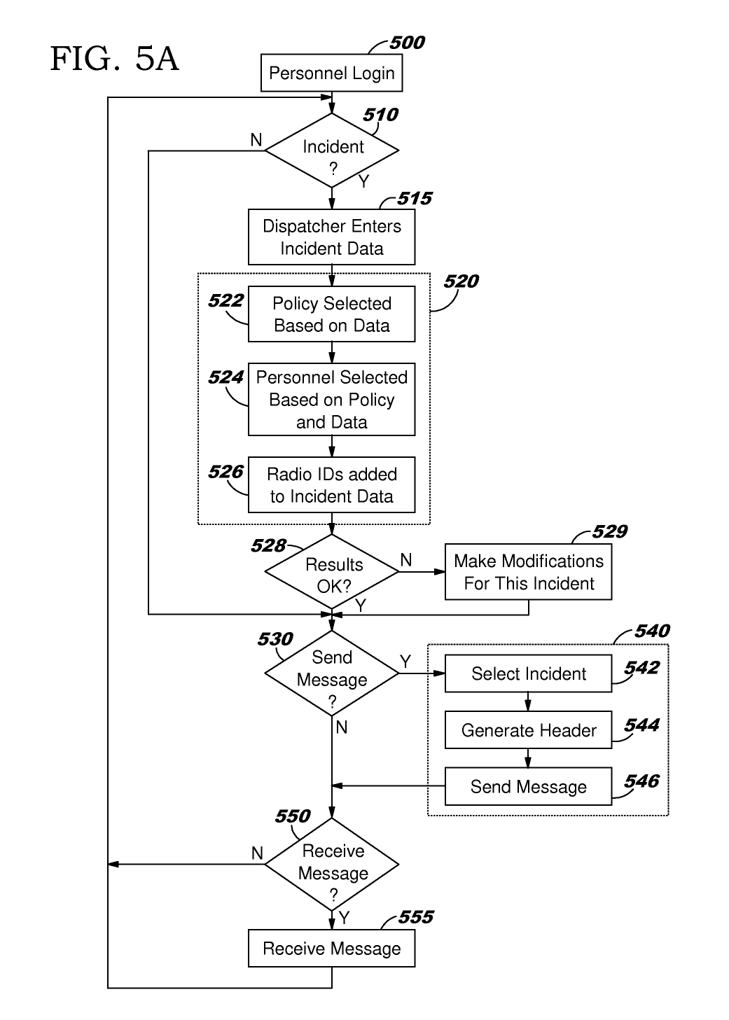

FIGS. 4A through 4E illustrate various data structures which may be used in accordance with a first embodiment. Alternative data structures or databases may be used to implement the first embodiment or various other embodiments. The information stored in these data structures may be updated dynamically and automatically. For example, the stored location of an officer may change as the reported location of that officer changes.

FIG. 4A illustrates a login data structure 400 identifying the various radios and personnel which may be logged into the system in accordance with the first embodiment. In this embodiment, there is a one record for each person logging into the system even if that person is utilizing multiple radios. With this approach, it would be easy for a person to log into the system once and indicate each radio that person is utilizing. Alternative embodiments may use a separate record for each radio.

The first element 402 is a unique personnel identifier (ID). That identifier may be used from another database such as a full personnel database. The second element 404 is the type of personnel. For example, a dispatcher, a police officer, a fireman, etc. This way the system can easily determine what types of personnel are available at any time. The third element 406 is a list of unique radio identifier(s) the person may be using at a given time. This allows for communications to that person to reach each of the radios used by that person. For example, if a police officer leaves his vehicle, then that officer may still be reached on his or her mobile radio. Each radio has a unique identifier that may be used from another database such as a full radio inventory. This identifier is also used for distributing radio communications as will be described below.

The fourth element 408 is the shift of the person logging into the system. This may be important in allocating incidents where there may be overlap of shifts. That is, a person ending their shift should generally not be assigned an non-emergency incident which may require a long time to resolve. The fifth element 410 is the region (e.g. beat in the case of a police officer) where the person is assigned. Generally a person should not be sent to an incident outside of that person's assigned area. The sixth element 412 is the vehicle ID of the vehicle assigned to the person. Given that vehicles often have tracking devices, this type of information could become important. The seventh element 414 is the location of the person. That may be derived from a GPS (global positioning system) unit located in the radio used by the person or the vehicle being driven by the person. This information is used to identify which personnel are closest to an incident. Although addresses may be used, GPS coordinates may be preferred because the geodesic distance a person is from an incident can be calculated mathematically. Direction and velocity may also be included with this location information.

Additional elements may be collected during the login process and included in this data structure. Further elements may be obtained from other databases such as a personnel database. These additional elements may be useful in implementing the policies described below.

FIG. 4B illustrates an incident data structure 420 that identifies the ongoing incidents in progress in accordance with the first embodiment. In this embodiment, there is a one record for each reported incident even if multiple personnel are assigned to the incident. Alternative embodiments may use a separate record for each person assigned to an incident.

A first element 422 is a unique identifier (ID) for that incident. This identifier may be generated in sequence as the incidents are entered into the system. The identifier may also include a date and time stamp within the identifier. A second element 424 is an incident type such as a burglary, an automobile accident, etc. This will be useful in assigning the appropriate personnel for the incident. A third element 426 is an incident priority such as low, medium, high, critical, etc. This will also be useful in assigning the appropriate personnel for the incident. A fourth and fifth elements 428 and 430 are an incident region and an incident location. These elements are important in identifying which personnel are assigned to that region and closest to the incident.

A sixth element 432 identifies the personnel assigned to the incident. For cross-referencing and ease of use, the personnel ID of each person assigned to the incident may be used. This can include the dispatcher, the police officer(s), firemen, etc. This can easily be modified over time depending on circumstances. In an alternative embodiment, the radio IDs and vehicles of the personnel assigned may be listed instead. Additional elements may be collected during the process of logging in the incident or updating the incident by a 911 operator or other personnel and included in this data structure. Further elements may be obtained from other databases. These additional elements may be useful in implementing the policies described below.

FIG. 4C illustrates a policy data structure 440 that identifies the policies that would apply for a given incident in accordance with the first embodiment. An incident type 442, incident priority 444 and incident region 446 are discriminators within this embodiment. That is, the policies may be indexed based on these criteria. For example, some regions may be known for higher volatility and more personnel may be assigned to a given incident (e.g. back-up) for an incident in that geographic region. Alternative embodiments may include other types of discriminators depending on the policies that may be applied.

A policy 448 is provided for that incident type, priority and region. The policy may be a set of criteria that may be applied depending on the discriminators and other elements from the login and the incident data structures or other data structures or databases. For example, the policy for a burglary in progress may assign those police officers closest to the incident regardless whether it is within their region (beat). For another example, a minor traffic accident may be assigned to a police officer not handling another higher priority incident.

FIG. 4D illustrates a data structure of a dispatcher radio communication header 460 in accordance with the first embodiment. This header may be at the beginning of each radio communication generated by a dispatcher. This header allows each emergency personnel radio to determine whether that radio should receive and play that message for the emergency personnel utilizing that radio or disregard that message.

The header includes a dispatcher radio ID 462, an incident ID 464 and radio ID(s) 466. The dispatcher radio ID is to identify the radio sending the communication, the incident ID identifies which incident the communication is regarding, and the radio ID(s) are the radios being used by the emergency personnel assigned to this incident. This allows the receiving radios to discriminate whether the communication is intended for that radio and the person logged into the system with that radio.

FIG. 4E illustrates a data structure of a personnel radio communication header 480 in accordance with the first embodiment. It includes the radio ID 482 of the radio sending the message and the ongoing incident ID(s) 484 assigned to the person with that radio. Header 480 may also include location information such as GPS coordinates of the radio. This header allows other emergency personnel radios to determine whether those radios should disregard that message or receive and play that message for the emergency personnel utilizing those radios.

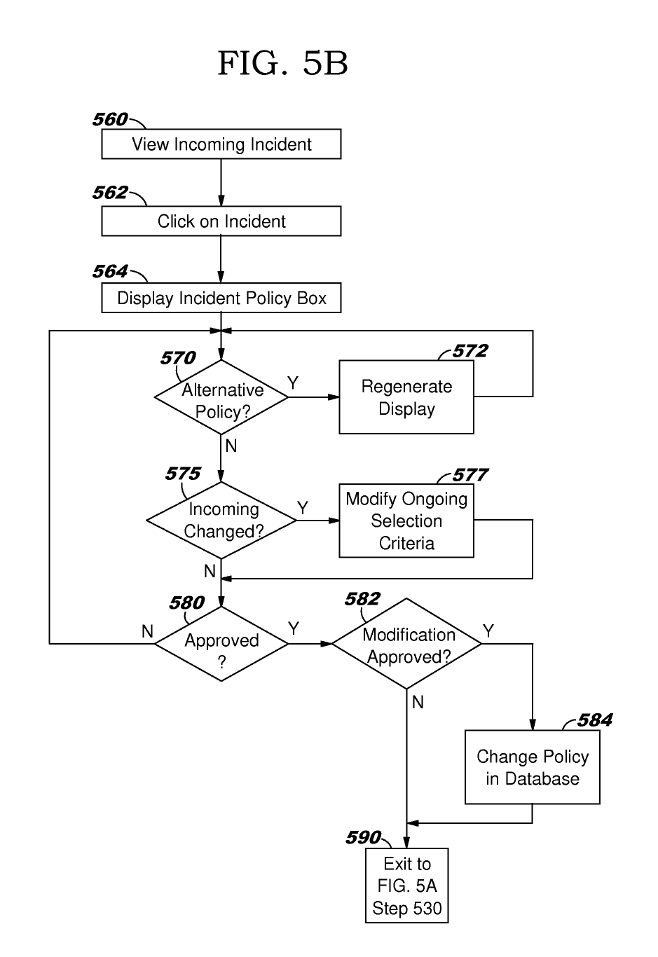

FIGS. 5A and 5B are flowcharts of the application of a policy to an incident in which various embodiments may be implemented. FIG. 5A provides an overview of this process with FIG. 5B providing a more detailed description of the process with respect to a dispatcher modifying the application of a policy to an incident. The following initial description will be referencing the first embodiment. Various alternatives may be used for the first embodiment or for alternative embodiments. In a first step 500 various personnel log into the system generating much of the data shown in the login data structure of FIG. 4A. Some of this data may come from an indexed personnel database such as the personnel type.

In a second step 510, it is determined whether an incident has been reported or if a previously reported incident is being updated. This may be indicated by the person receiving the incident report selecting a menu item on that person's computer system. This incident may be reported to a 911 operator, a dispatcher also acting as a 911 operator, or an emergency person (e.g. police officer) in the field. If no incident is being reported or updated, then processing continues to step 530 below, otherwise processing continues to step 515. In step 515, the person receiving the incident report will enter data about that incident into an incident data structure such as shown in FIG. 4B. If a new incident, then a new incident ID number may be generated. The incident data can include the type of incident (e.g. traffic accident) and location.

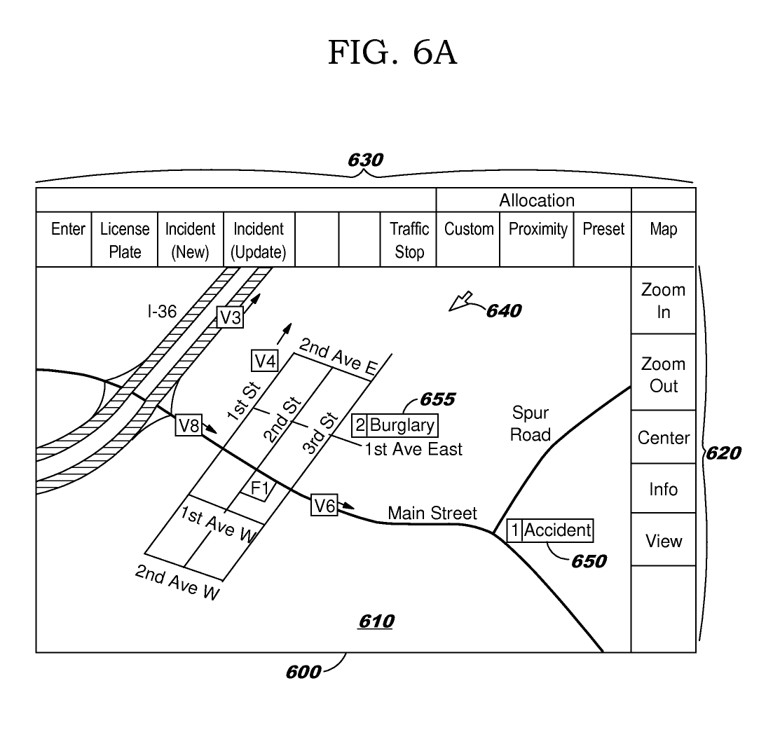

In step 520, a policy is initially applied to the new or updated incident in a three step process 522, 524 and 526 followed by a decision in step 528. This process is automated and does not require human intervention until step 528. This includes selecting a policy from the policy data structure based on data in the incident data structure in step 522. For example, the policy selected may be based on incident type, incident priority and incident location Additional data may be used in alternative embodiments. Personnel, also known as resources, are then selected in step 524 from the login data structure that meets the guidelines of the selected policy. This selection may utilize data in the incident data structure and the login data structure as well as other data structures. For example, the policy may utilize various data elements such as personnel type, personnel location and personnel availability. This selection can include emergency personnel near the scene of the incident such as police officers, firemen, etc. but may also include the dispatcher, management of the emergency personnel and others according to the policy selected. Personnel availability may be determined by reviewing the incident data structure to see which personnel are allocated to other incidents. In an alternative embodiment, the personnel data structure may include incident allocation information to allow rapid determination of personnel availability. In step 526, radio IDs for selected personnel may be added to the incident data structure for easy access when messages are sent or received. Additional radio IDs may be selected for other personnel such as management and support personnel for selected personnel. For example, a police of fire sergeant may listen to the radio traffic of all personnel reporting to that sergeant. Also, certain personnel may support selected personnel such as a dispatcher. These relationships may be determined and utilized from login data structure or other personnel database. In step 528, the personnel selected are identified to the dispatcher and relevant command personnel by the computer system. If changes are desired, then in step 529 the dispatcher may make those changes. Typically any such changes may require approval of the relevant command personnel. FIG. 5B, described below with reference to FIGS. 6A and 6B, provides greater detail of a dispatcher modifying a policy to be implemented for an incident relative to steps 528 and 529.

Subsequently in step 530 it is determined whether the dispatcher or other person wants to send a radio message regarding an incident. This may be initiated by the dispatcher selecting a menu item on the dispatcher's computer system. If not, then processing continues to step 550, otherwise processing continues to step 540. Step 540 is performed in a three step process 542, 544 and 546. In a first step 542, the dispatcher selects an incident for a message using the dispatcher's computer system. In the case of a recently entered or updated incident, this step may not be necessary. As a result of this selection, in step 544 the computer system provides to the dispatcher's radio a header including the dispatcher radio ID, incident ID, and the radio IDs of the personnel intended to receive the message. In a third step 546, the radio message is sent including the header from the computer system. This header allows each digital radio listening to the frequency to determine whether the message should be disregarded or received and put on that radio's speaker.

Subsequently, in step 550, it is determined whether a radio message is being received from the field that is intended for the recipient such as the dispatcher in this example. If the message includes an incident ID that the dispatcher is handling or if the radio ID of the sender matches any of the radio IDs of personnel assigned to the dispatcher, the processing continues to step 555. Otherwise, the message is disregarded and not processed and processing returns to step 510. In step 555, the message is received and put on the dispatcher's radio speaker or headset. The computer system may also indicate the sender of the message onto the dispatcher's computer system display. Processing then returns to step 510.

When a police officer or other emergency person in the field sends a message, the header for that officer's radio should include the incident ID for the incident being handled by the officer. If the officer is handling multiple incidents, then the officer should select a specific incident for the message in a manner similar to that described above for the dispatcher. However, if that is not practical such as when the officer is using a mobile radio, the header should include the incident IDs for each of the outstanding incidents being handled by that officer. As a result, other officers handling any of those same incidents may hear the outgoing messages from that officer.

FIG. 5B, with reference to FIGS. 6A and 6B, provides greater detail of a dispatcher reviewing, possibly modifying, and approving a policy to be implemented for an incident relative to steps 528 and 529 of FIG. 5A above. In a first step 560 the dispatcher may be viewing an incoming incident report on the dispatcher's display as shown in FIG. 6A. FIG. 6A is a pictorial representation of a display which may be viewed by a dispatcher or a police officer or other emergency personnel in which various embodiments may be implemented. The display shows a map 610 of a geographic region which may be navigated using navigation buttons 620. For example, by selecting a button for zooming in using a cursor 640 or by simply pressing the button with a fingertip, the image may zoom in. Other navigation buttons may be used to perform other navigation functions. Also shown are function buttons 630 which may be used for a variety of purposes. For example, if a license plate number needs to be checked against a database, a license plate button may be selected or pressed, which would generate a pop-up box where the dispatcher or officer may type in the license plate number. Voice recognition may also be used to enter such information such as when an officer is driving a police car.

Two different incidents are shown in the geographic region shown on map 610. A first incident indicator 650 represents an accident at the intersection of Main Street and Spur Road. A second incident indicator 655 represents a burglary at the intersection of 3rd street and 1st Avenue East. These incidents may have been entered onto the map by a 911 operator or the dispatcher. The priority or severity of an incident may be displayed by the use of background color in incident indicator 665. The map also shows each available police and fire resources based on which radios have logged into the system and which are constantly updated using GPS data automatically sent from each vehicle's computer system. For example, there is a police officer in vehicle V6 east of town headed east on Main Street, a police officer in vehicle V8 west of town also headed east on Main street, a police officer in vehicle V4 headed north on 1st Street, and a police officer in vehicle V3 headed north on I-36. There is also a fire unit F1 located in town at Main Street and 2nd Street. The personnel sent to each incident will be based on the policies contained within the policy data structure. For example, if the accident is minor, a police officer may be sent to assist. If there are reported injuries, then an ambulance may be sent. If there is a fire or excessive leaking liquids, a fire truck may be sent. One or more police cars may be sent to the burglary depending on the reported severity of the burglary and depending on whether the burglary may still be in progress.

Once the data for each incident has been entered into the system such as by a 911 operator, each incident may be blinking on a displayed map on the dispatcher's display. This blinking indicates that policies have been automatically applied to each incident, but confirmation is needed to from the dispatcher. The dispatcher may then click on an incident in step 562 to initiate the review of the policy applied to that incident. That will initiate the display of a pop-up or dialog box 660 in step 564 as shown in FIG. 6B.

In this example, the dispatcher has clicked on burglary incident 655. The dialog box is entitled “Radio Policy Review” as shown in title box 662. The incident ID is “2012-023949” as shown in box 664. The type of incident is a “Burglary in Progress” as shown in type box 666. The incident priority is “High” as shown in box 668. Policy box 670 is shown with the name of the policy used to assign police officers shown in box 672. In this case, all available officers within a 2 mile radius are included due to the nature and priority of the incident. Alternative policies are also available to be selected by the dispatcher including a smaller radius in box 674, the inclusion of a SWAT team in box 676, or a custom selection in box 678. Please note that the possible radii that can be used by policies identified in policy box 670 are shown on map 685. Also shown is a box 680 identifying whether any units coming into the identified area will be added automatically by the system as receiving radio traffic related to the incident. Also shown is a box 690 for approved the policy currently shown in the dialog box. If a policy other than the standard policy is selected and approved, another box 692 is available for the dispatcher to approve the use of the alternate policy for that incident type and location in the future.

Additional information is shown in dialog box 660 including the epicenter or location of the incident as well as the police units and radios that would be included by the standard policy. For example, vehicle V3 has a vehicle radio V3P3 and a walkie-talkie radio WT3 corresponding to an officer P3. For another example, vehicle V6 has a vehicle radio V6P6, a walkie-talkie WT6 for police officer P6, but also WT7 for another police office P7 riding in the V6 police vehicle.

If the dispatcher selects an alternate policy such as by double clicking box 674, then step 570 would detect that selection, that policy would be implemented and dialog box would be updated in step 572. If the dispatcher deselects or reselects incoming units box 680, then step 575 would detect that selection and the selection criteria for that incident would be updated to reflect that selection in step 577. If the dispatcher approves the displayed policy in box 692, then that selection would be detected in step 580 and processing would proceed to step 582. If the displayed policy was the original policy or if it was a modified policy and box 692 was not selected, then processing would exit back to step 530 in FIG. 5A described above. Otherwise the policy identified for that incident type and location would be updated to the approved alternative selection by the dispatcher in step 584 before processing returns to step 530 of FIG. 5A described above.

Many alternative embodiments for reviewing, modifying and approving policies could be implemented. For example, a policy radius could be entered in a separate input box, pull down boxes could be used to show more alternative policies, or the dispatcher may be able to move the epicenter based on anticipated escape path of the person committing the reported incident.

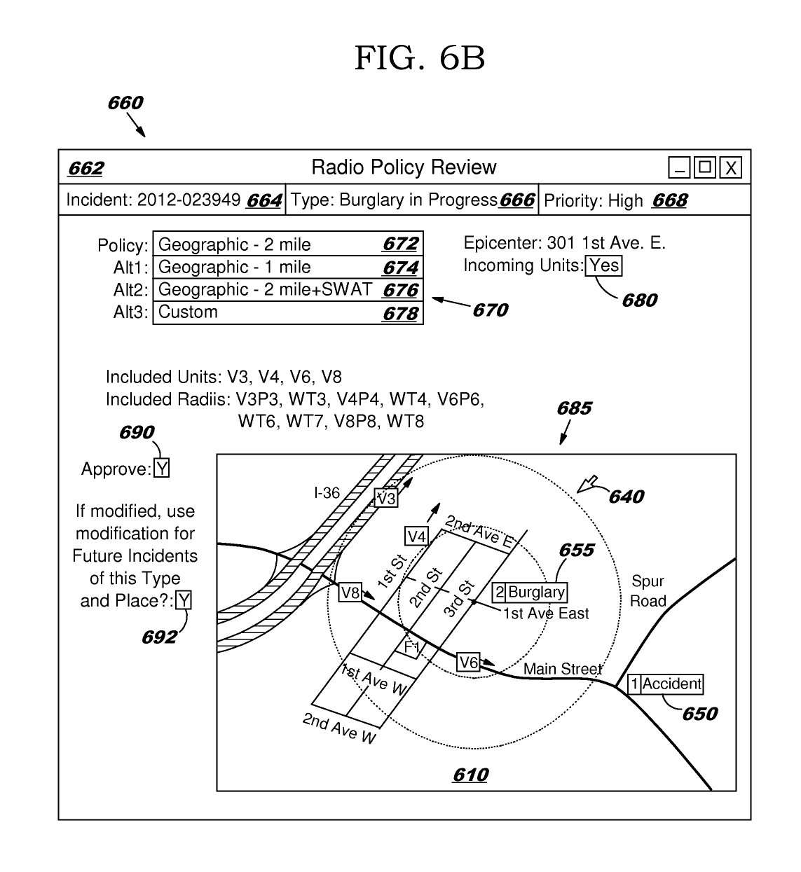

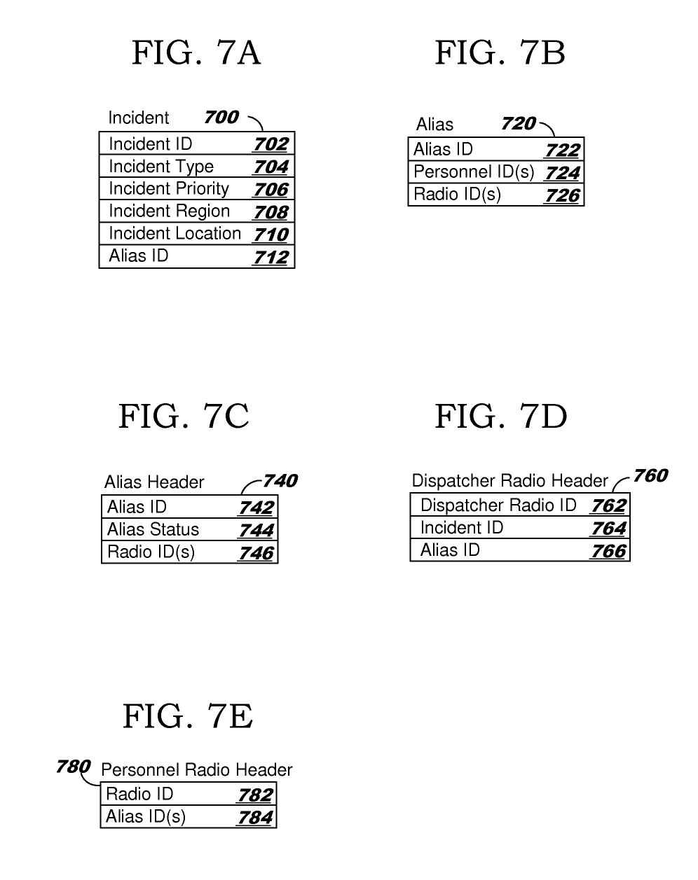

FIGS. 7A through 7E illustrate various data structures which may be used in accordance with a second embodiment. The login and policy data structures of FIGS. 4A and 4C may also be utilized with this second embodiment. This embodiment utilizes aliases in place of radio IDs when referring to multiple radio IDs. This is useful when many radio IDs may be used in a radio communication header which may slow those communications. The information stored in these data structures may be updated dynamically and automatically. For example, the stored location of an officer may change as the reported location of that officer changes.

FIG. 7A illustrates an incident data structure 420 that identifies the ongoing incidents in progress in accordance with the second embodiment. In this embodiment, there is a one record for each reported incident even if multiple personnel are assigned to the incident.

A first element 702 is a unique identifier (ID) for that incident. This identifier may be generated in sequence as the incidents are entered into the system. The identifier may also include a date and time stamp within the identifier. A second element 704 is an incident type such as a burglary, an automobile accident, etc. This will be useful in assigning the appropriate personnel for the incident. A third element 706 is an incident priority such as low, medium, high, critical, etc. This will also be useful in assigning the appropriate personnel for the incident. A fourth and fifth elements 708 and 710 are an incident region and an incident location. These elements are important in identifying which personnel are assigned to that geographic region and closest to the incident.

A sixth element 712 identifies the alias ID being utilized for this incident. The alias ID may be used to identify the radios and personnel assigned to the incident. Additional elements may be collected during the process of logging in the incident or updating the incident by a 911 operator or other personnel and included in this data structure. Further elements may be obtained from other databases. These additional elements may be useful in implementing the policies described below.

FIG. 7B illustrates an alias data structure 720 identifying the various radios and personnel which may be represented by an alias ID in communications. There could be an alias ID utilized for each incident. There could also be alias IDs for various management structures. For example, a police sergeant and all police officers may be represented by a single alias ID which may be useful for various types of communications not related to an incident.

A first element 722 is a unique alias ID. A second element 724 is a list of personnel IDs represented by the alias ID. A third element 726 is a list of radio IDs represented by the alias ID. This list of aliases may be maintained on a dispatcher computer system or a centralized system

FIG. 7C illustrates a data structure of an alias header 740 in accordance with the second embodiment. This header may be sent once by a dispatcher when a new alias ID is generated and again when that alias is eliminated. The alias header is not necessarily at the beginning of a radio message. It may be sent silently across the radio waves or even sent through computer systems which then inform local radios wirelessly of the alias. Each radio can save these alias headers to know what messages to listen to a put of speaker.

A first element 742 is the unique alias ID from alias data structure 720. A second element 744 is the status of the alias ID. For example, if this is a new alias ID, then the status may be “new”. If this is an alias ID being eliminated, then the status may be “drop”. If the radio IDs related to this alias ID are modified, then the status may be “change”. A third element 746 is a list of the radio IDs related to this alias ID.

FIG. 7D illustrates a data structure of a dispatcher radio communication header 760 in accordance with the second embodiment. This header may be at the beginning of each radio communication generated by a dispatcher. This header allows each radio to determine whether that radio should receive and play that message for the emergency personnel utilizing that radio or disregard that message.

The header includes a dispatcher radio ID 762, an incident ID 764 and alias ID 766. The dispatcher radio ID is to identify the radio sending the communication, the incident ID identifies which incident the communication is regarding, and the alias ID identifies indirectly the radio IDs are the radios being used by the emergency personnel assigned to this incident. This allows the receiving radios to discriminate whether the communication is intended for that radio and the person logged into the system with that radio.

FIG. 7E illustrates a data structure of a personnel radio communication header 780 in accordance with the first embodiment. It includes the radio ID 782 of the radio sending the message and the alias ID(s) 784 assigned to the person with that radio. Header 780 may also include location information such as GPS coordinates of the radio. This header allows other emergency personnel radios to determine whether those radios should disregard that message or receive and play that message for the emergency personnel utilizing those radios.

The FIG. 5 flowchart may utilize the second embodiment data structures of FIGS. 7A through 7E. For example, in step 526 an alias ID may be generated representing radio IDs of personnel assigned to that incident. With this approach, the incident data structure will only have one alias ID per incident rather than multiple radio IDs. As a result, when the dispatcher sends a communication such as in step 540, one alias ID is used in the dispatcher radio header instead of multiple radio IDs, thereby speeding communications.

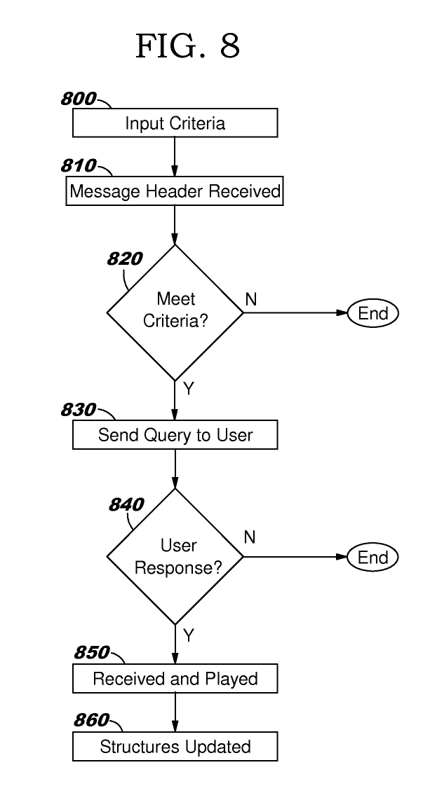

FIG. 8 is a flowchart of a user modifying a policy allocation in which various embodiments may be implemented. Once a policy has been implemented, messages may only be sent to radios that are identified within the message header as determined by the above described processes. However, a user may wish to override this policy for a radio used by that user.

In a first step 800, the user generates a set of criteria that may be used to identify messages which the user may wish to hear. For example, a user may wish to hear all radio traffic being sent to another specific radio. For another example, a user may wish to listen to radio traffic regarding incidents within a given region. This set of criteria may be stored on the radio being used by that user or the criteria may be stored in a central database. In an alternative embodiment, the criteria may be examined against policies on overrides to determine if the user is authorized to listen to radio traffic as requested. If not, then the criteria may be altered or deleted.

In a second step 810, the user's radio receives a header for an incoming radio message. The information in the header is then compared against the criteria previously set forth by the user in step 820. This comparison may be performed by looking for certain radio IDs or aliases in the header, or it may require a query to a central incident data structure to see if the message meets the criteria set for by the user. If the message header does not meet the user's criteria, then processing exits and the message is not played for the use. If the message header meets the user's criteria, then processing continues to step 830.

In step 830, the user is queried to confirm whether the user wishes to receive the incoming message. This allows the user to reject any radio traffic not desired. This step may be performed only the first time a given criteria is matched, such as an incident in a given region, or may be performed for each message by a beep or tone. This allows the user to avoid listening to extra radio traffic when the user may be very busy with an emergency or other incident.

In step 840, it is determined whether the user approved or denied listening to the message. If the user does not respond to the query, that may be viewed as a denial. If a denial, then processing exits and the message is not received or played. If the user approves, then in step 850 the message is received and played by the user's radio for the user to listen to. In step 860, various data structures may be updated. For example, if an alias is being used in the message header, that alias data structure may be updated to include the user and the radio ID of the user. This allows for all future messages using that alias to be automatically received and played by the user's radio.

Many alternative embodiments of the above described hardware, software and processes could be implemented. For example, the various radios utilized may be full duplex, half duplex, simplex or a combination of thereof. This system could be implemented in all these types of systems, including the use of message collision detection techniques with retransmission of messages to address issues such as message clipping. In addition, some digital radios may have the capability to shunt some message traffic to an alternate channel and then intermix the messages as instructed by a policy.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as software to implement policies for managing the distribution of radio communications. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing digital radio transmissions comprising:
determining a group of selected radio receiving units for a set of digital radio transmissions according to a policy; and
transmitting the set of digital radio transmissions by a radio transmitting unit only to the group of selected radio receiving units.

2. The method of claim 1 further comprising:
displaying a proposed group of radio receiving units as the group of selected radio receiving units according to the policy;
accepting user input to modify the proposed group of radio receiving units as the group of selected radio receiving units; and
accepting user input to confirm the modified group of radio receiving units as the group of selected radio receiving units.

3. The method of claim 2 further comprising accepting user input to modify the policy while accepting user input to confirm the modified group of radio receiving units as the group of selected radio receiving units.

4. The method of claim 1 wherein the policy is selected from a group consisting of incident type, incident location, and incident priority.

5. The method of claim 4 wherein the selected policy allocates resources based on factors from a group consisting of personnel function, personnel location, and personnel availability.

6. The method of claim 5 wherein the policy allocates receiving units based on factors from a group consisting of allocated personnel, allocated personnel manager, and allocated personnel support.

7. The method of claim 1 further comprising allowing a user to add a radio receiving unit assigned to the user to the group of selected radio receiving units if allowed by the policy.

8. The method of claim 7 further comprising:
displaying a proposed group of radio receiving units as the group of selected radio receiving units;
accepting user input to modify the proposed group of radio receiving units as the group of selected radio receiving units;
accepting user input to confirm the modified group of radio receiving units as the group of selected radio receiving units; and
accepting user input to modify the policy while accepting user input to confirm the modified group of radio receiving units as the group of selected radio receiving units.

9-24. (canceled)
